(19) United States
(12) Patent Application Publication
(10) Pub. No.: US 2021/0178666 A1
(43) Pub. Date: Jun. 17, 2021

(54) BUILD MATERIAL COMPACTION

(71) Applicant: HEWLETT-PACKARD DEVELOPMENT COMPANY, L.P., Spring, TX (US)

(72) Inventors: Adrien CHIRON, Sant Cugat del Valles (ES); Mohammad JOWKAR, Sant Cugat del Valles (ES); Diego Javier MOSTACCIO, Sant Cugat del Valles (ES)

(21) Appl. No.: 17/049,874

(22) PCT Filed: Aug. 8, 2018
(86) PCT No.: PCT/US18/45822

§ 371 Date: Oct. 22, 2020

(51) Int. Cl. B29C 64/153; B29C 64/165

(52) U.S. Cl. CPC B29C 64/153; B29C 64/245; B29C 64/165

(57) ABSTRACT

According to one example, there is provided a method of preparing build material in a build material supply module. The method comprises moving a supply platform within a build material supply module in a predetermined manner to compact build material within the supply module.

### BACKGROUND

Additive manufacture systems, more commonly known as three-dimensional (3D) printing systems, may generate 3D objects by selective solidification of portions of successive layers of a build material formed on a movable build platform. Some such systems may use a powdered, or powder-like, build material comprising, for example, granular particles. Such a build material may include, for example, build materials formed from of any suitable plastic, ceramic, or metal material.

### BRIEF DESCRIPTION

Examples will now be described, by way of non-limiting example only, with reference to the accompanying drawings, in which:

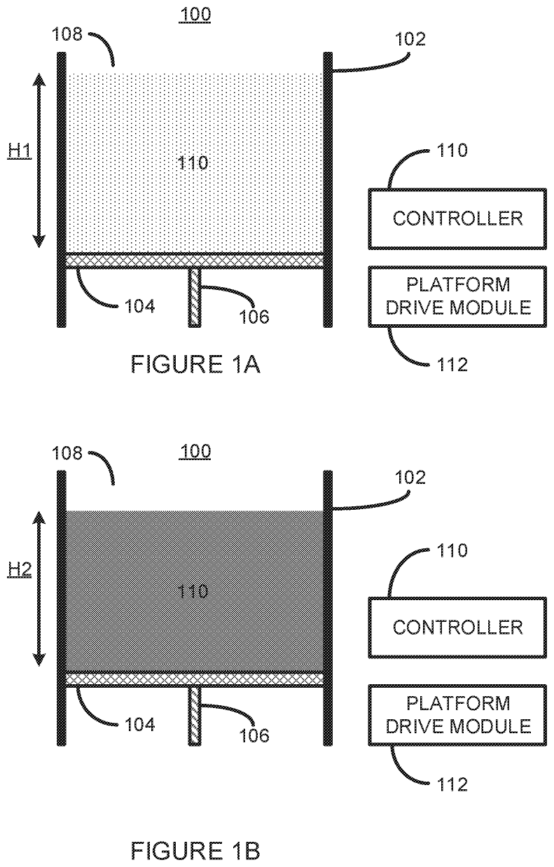

FIGS. 1A and 1B are side views of a simplified build material supply module according to one example;

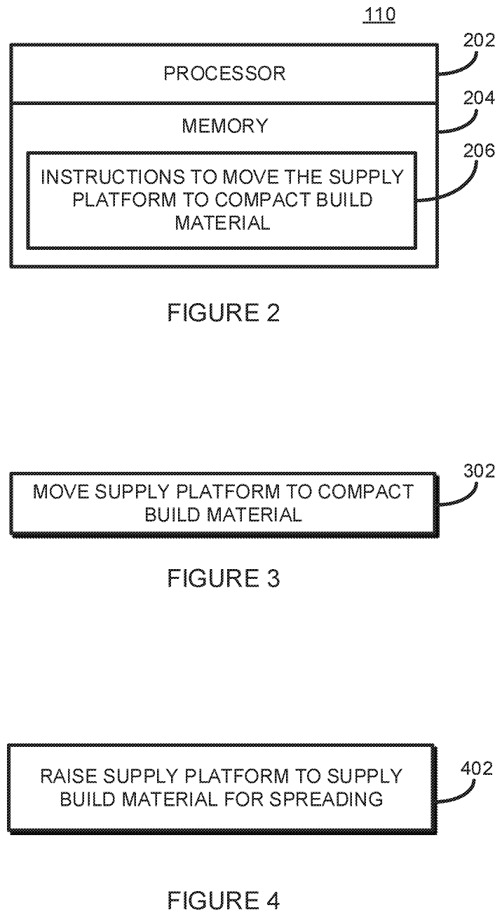

FIG. 2 is a block diagram illustrating a supply module controller according to one example;

FIG. 3 is a flow diagram outlining operation of a build material supply module according to one example;

FIG. 4 is a flow diagram outlining operation of the build material supply module according to one example;

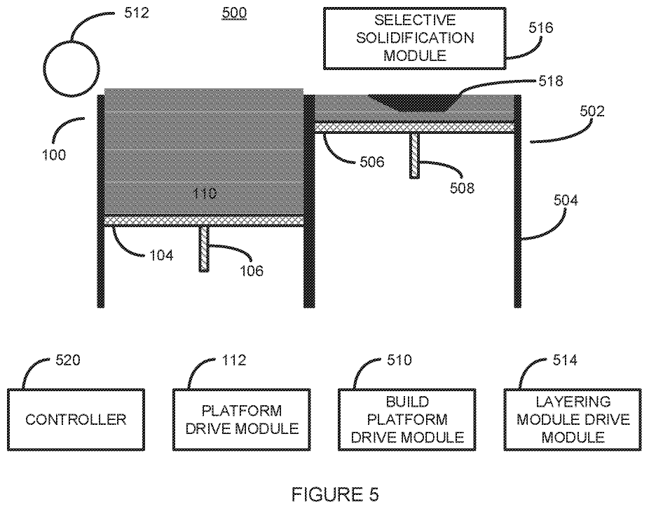

FIG. 5 is a block diagram showing a side view of a simplified three-dimensional printing system according to one example;

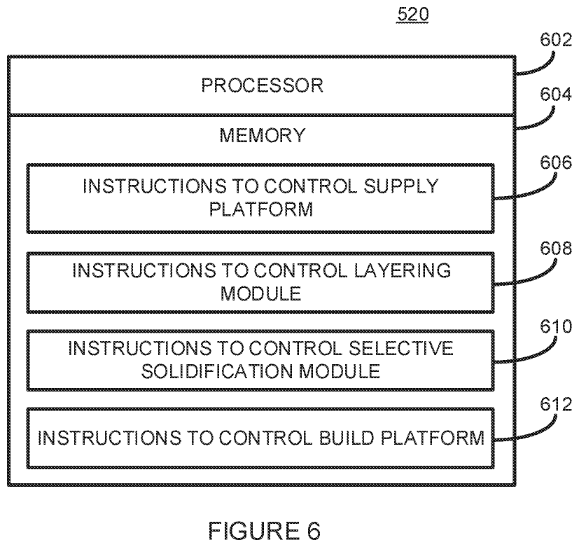

FIG. 6 is a block diagram illustrating a 3D printing system controller according to one example;

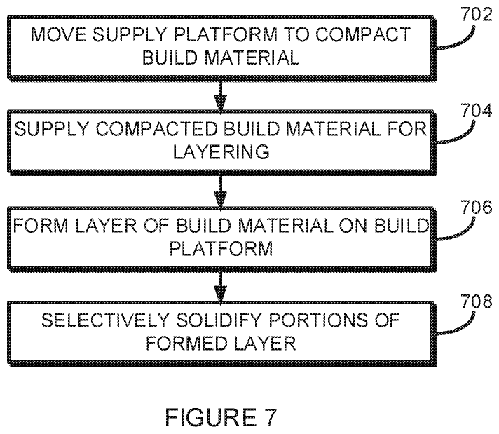

FIG. 7 is a flow diagram outlining operation of a three-dimensional printing system according to one example;

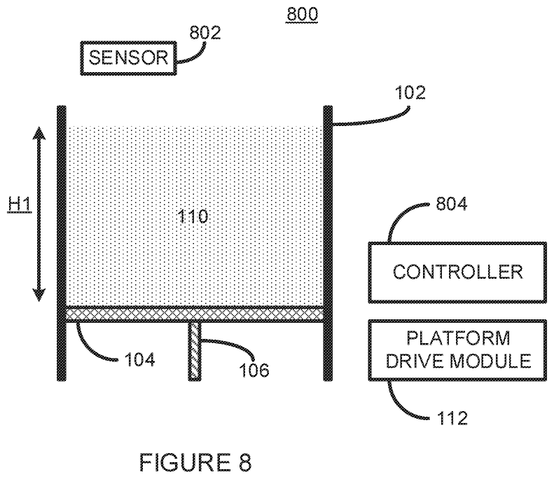

FIG. 8 is a side view of a simplified build material supply module according to one example; and

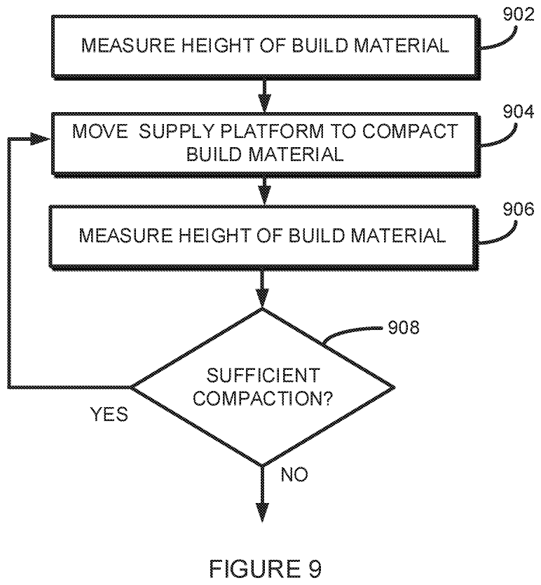

FIG. 9 is a flow diagram outlining operation of a build material supply module according to one example.

### DETAILED DESCRIPTION

A key process of powder-based 3D printing systems is the formation of a uniform thickness layer of build material on a build platform, or on a previously formed layer of build material. Having a uniform thickness layer enables high quality 3D objects to be generated.

The formation of a layer of build material often involves a build material supply module to provide a predetermined volume of build material on a supply platform to one side of the build platform. A recoater mechanism, such as a roller or a wiper blade, may then spread the provided volume of build material over the build platform to form the layer of build material.

To ensure formation of build material layers having a uniform thickness, the mechanism which supplies the predetermined volume of build material has to accurately, and repeatedly, provide the predetermined volume of build material for spreading.

Referring now to FIG. 1, there is shown a side view of a simplified build material supply module 100 for supplying a predetermined volume of build material for spreading over a build platform. The supply module 100 comprises a set of walls 102 which may, for example, form an open cuboidal structure. Within the walls 102 is positioned a supply platform 104 that has cross-section to fit within the walls 102 and may comprise sealing elements to effectively seal the build platform against the walls 102. The supply platform 104 is movable vertically within the walls, for example through a drive mechanism 106 such as a piston, a rack and pinion configuration, a screw thread, or the like. The drive mechanism 106 may be moved, for example, using a supply platform drive module 112. The supply platform 104 and walls 102 form an open-topped variable volume build material supply chamber 108. As shown in FIG. 1A, the supply chamber 108 may be filled with a build material 110 to height H₁ as measured from the top of the supply platform 104. A controller 110 may, for example, by controlling the supply platform drive module 112, cause the supply plafform 104 to move up or down within the supply chamber 108. In one example, the controller may cause the supply platform 104 to move up and/or down at different speeds, as will be described below.

Referring now to FIG. 2, there is shown a block diagram illustrating the controller 110 in more detail. The controller 110 comprises a processor 202 such as a microprocessor, microcontroller, or the like. The processor 202 is coupled to memory 204, for example via a communication bus (not shown). The memory 204 stores instructions 206 to move the supply plafform 104 to compact build material in the supply chamber 108. The instructions 206 are machine readable instructions that, when executed by the processor 202, cause the controller 110 to move the supply platform 104 to compact build material present in the supply chamber 108.

Operation of the system 100 is described now with further reference to the flow diagram of FIG. 3.

Initially, build material 110 is received in the supply module 100 in any suitable manner. For example, the build material 110 may be poured into the supply module 110 by a user from a box or other container containing the build material 110. In another example, the build material 110 may be supplied to the supply module 110 by a build material management system (not shown).

The act of filling the supply module 100 with build material 110 may cause build material particles to mix with air as the build material is being introduced into the supply module 100. As a result, the build material 110 may, upon filling, have a first density or compaction level. If left for a sufficient period of time, for example, the build material particles may (depending on the build material characteristics) naturally compact under gravity to a have a second density or compaction level higher than the first density or compaction level. If build material from the supply module 100 is used to form layers of build material for processing by a 3D printing system before the density or level of compaction has stabilized, over the course of a 3D printing print job (which may last for several hours), the density or compaction level of build material used to form the layers may change over time. This may lead to layers of build material used in a 3D print job being formed from build material have different densities or compactions levels, which may in turn lead to generated 3D objects having non-intended properties.

At block 302, the controller 110 controls the supply plafform 104 to move within the supply module 100 in a predetermined manner to cause compaction of the build material 110. In one example, the controller 110 causes the supply plafform to move up by a first distance, and then down by the first distance over a predetermined number of compaction cycles. For example, the first distance may be a distance in the range of about 10 to 20 mm, or about 10 to 30 mm, or about 10 to 40 mm, or about 5 to 10 mm, or about 5 to 20 mm, or about 5 to 30 mm. In other examples the first distance may be in a lower range, or a higher range. In another example, the first distance may be in a range having a lower end between about 2 to 10 mm, or a having a higher end between about 20 to 50 mm. In one example, the amplitude of supply plafform movement may be asymmetrical, or aperiodic, such that different ones of the up and down movements of the supply platform move the supply platform by a different distance.

In one example, the speed at which the supply platform 104 is moved by the first distance may be higher than a speed at which the supply platform 104 is moved when supplying a predetermined volume of build material for spreading. For example, the supply platform 104 may be moved at a speed of about 10 cm/s, or about 5 cm/s, or about 15 cm/s. In other examples, the supply plafform 104 may be moved at other speeds.

In one example, the number of repeated raising and lowering cycles of the supply plafform may be about 5 cycles, about 10 cycles, about 15 cycles, about 20 cycles, about 25 cycles, about 30 cycles, about 40 cycles, about 50 cycles, or any other suitable number of cycles.

In one example, during the compaction cycles, the upper level of the build material within the supply module 100 is not moved above the upper level of the supply module 100 such that the build material 100 is contained completely within the supply module 100 during compaction. This may help prevent build material from becoming airborne during the compaction process.

In one example, moving of the supply platform in the manner described above may impart small shocks or impacts to build material within the supply module 100, which in turn causes the build material 110 to compact, as illustrated in FIG. 1B. As shown in FIG. 1B, the build material 110 has a height of H₂, which is less than the original height H₁.

Depending on the height of the supply module 100, the amount of build material therein, and the method used to supply material to the supply module 100, the build material 100 may compact, for example, by between about 5 to 10% of its original height H₁. In other examples the build material 100 may compact by a greater or a lesser amount.

In one example, the number and nature of the compaction cycles may be predetermined based on the type of build material 110 being used. For example, through experimentation it may be determined that a given type of plastic build material should undergo 30 compaction cycles of an amplitude and a particular speed, whereas a different kind of build material should undergo 20 compaction cycles.

After completion of the compaction cycles, the controller 110 may control the supply platform 104 to raise the supply platform to supply compacted build material for spreading over a build platform. This is illustrated at block 402 in FIG. 4. For example, the controller 110 may raise the supply platform 104 such that a predetermined height of compacted build material 110 is positioned above the upper level of the supply module such that this build material may be used to form a layer of build material on a build platform.

In one example, the supply platform 104 may be raised manually by a user, for example through a user interface provided on a 3D printing system, until the top surface of the compacted build material 110 is positioned at the top of the supply module 100. In another example, the supply platform 104 may be raised until a build material height detector indicates that the top surface of the compacted build material 110 is positioned at the top of the supply module 100. In a further example, supply platform 104 may be progressively raised, and a layering module may operate to form layers of build material on a build plafform until a layer forming detection module (not shown) detects that a complete and acceptable layer of build material has been formed on the build platform. This may use, for example, a vision system or one or multiple height sensors. In yet another example, the supply platform 104 may be progressively raised, and a layering module may operate to form layers of build material on a build plafform until it is detected that excess build material remaining after a layer forming process is received in an excess build material overflow receiver.

In one example, the speed at which the supply platform 104 is raised to supply build material for spreading is lower than the speed at which the supply plafform 104 is moved to compact build material. For example, moving the supply plafform 104 at a slower speed when supplying build material 110 for spreading enables the supply plafform 104 to be moved more precisely, and thus enables a more accurate volume of build material to be provided.

Referring now to FIG. 5, which shows a side view of a simplified three-dimensional printing system 500, according to one example. The 3D printing system 500 incorporates the supply module 100 as described above.

The supply module 100 is positioned within the 3D printing system 500 adjacent to a build chamber 502, or adjacent to a build chamber receiving interface (not shown). The build chamber 502 is formed from a set of walls 502 which may, for example, form an open cuboidal structure. Within the walls 502 is positioned a build platform 506 that has cross-section to fit within the walls 502 and may comprise sealing elements to effectively seal the build plafform against the walls 502. The build platform 506 is movable vertically within the walls, for example through a drive mechanism 508 such as a piston, a rack and pinion configuration, a screw thread, or the like. The drive mechanism 508 may be moved, for example, using a supply platform drive module 510. The build plafform 506 and walls 504 form an open-topped variable volume build chamber.

In one example the build chamber 502 may be part of a removably installable build unit that may be present in the 3D printing system 500 during a printing operation and that may be removed after completion of a printing operation. In one example the supply module 100 and build chamber 502 may be part of a removably installable module that may be present in the 3D printing system 500 during a printing operation and that may be removed after completion of a printing operation. The may allow, for example, non-solidified build material in the build chamber 502 to be removed by a build material management station (not shown) and further allowing 3D printed objects to be removed. This may further allow the supply chamber 100 to be refilled with build material ready for use in a further 3D printing operation.

The supply module 100 may, as previously described, operate to initially compact build material 110 therein, and may then raise a portion of the build material 110 a predetermined height above the upper level of the supply module 100 to provide a volume of build material for spreading over the build plafform 506. In the example shown, a layer module 512, such as a roller or wiper blade, is provided on a movable carriage (not shown) such that the layering module 512 may be translated over the supply module 110 to spread a volume of build material over the build platform 506, or over a previously formed layer of build material. The layering module 512 may be controlled using a layering module drive module 514.

A selective solidification module 516 may then process the formed layer of build material to selectively solidify a portion or portions of the formed layer, for example based on a 3D object model of an object to be generated. In one example, the selectively solidification module comprises a laser, to directly melt or sinter portions of each formed layer of build material. Such a system may be referred to as a selective laser sintering (SLS) system.

In another example, the selective solidification module 516 may comprise a printhead to selectively apply a binding agent to portions of each formed layer of build material. The selective solidification module 516 may additionally comprise an energy source, such as an ultra-violet or infra-red energy source, to cause the applied binding agent to cure, thereby solidifying a portion of the build material. Such a system may be referred to as a binder jet system.

In another example, the selective solidification module 516 may comprise a printhead to selectively deliver an energy absorbing fusing agent onto portions of each formed layer of build material. The selective solidification module 516 may additionally comprise an energy source, such as an infra-red energy source, to generally apply energy to the whole of each formed layer of build material. Those portions of the build material on which fusing agent was applied heat up and up melt, sinter, or otherwise coalesce, whereas portions of the build material on which no fusing agent was applied will heat up sufficiently to melt, and therefore remove non-solidified. Such a system may be referred to a fusing agent and fusing energy system.

After each layer of formed build material is processed by the selective solidification module 516, the build platform is lowered by a predetermined amount, and the supply platform 104 is raised by a predetermined amount. A 3D dimensional object 518 may thus be formed within the build chamber on a layer-by-layer basis

The overall operation of the 3D printing system 500 is controlled by a controller 520, further details of which are shown in FIG. 6. The controller 520 comprises a processor 602 such as a microprocessor, microcontroller, or the like. The processor 602 is coupled to memory 604, for example via a communication bus (not shown). The memory 604 stores instructions 606 to control the supply platform 104 to initially compact build material in the supply chamber 108 and to subsequently provide build material for spreading over the build platform 506. The memory 604 also stores instructions 608 to control the layer module 512 to form successive layers of build material on the build plafform 506 by spreading build material provided by the supply module 100. The memory 604 also stores instructions 610 to control the selective solidification module 516 to selectively solidify build material of each formed layer of build material. The memory 604 also stores instructions 612 to control the build platform 506 to lower after each formed layer of build material has been processed by the selective solidification module 516.

These instructions are machine readable instructions that, when executed by the processor 202, cause the controller 520 to control the 3D printing system 500 in accordance with the flow diagram shown in FIG. 7.

Operation of the system 500 is described now with further reference to the flow diagram of FIG. 7.

At block 702, the controller 520 moves the supply platform 104 to move, for example, to raise and lower, in a manner as described herein, to compact build material that has been provided in the supply module 100.

At block 704, the controller 520 controls the supply plafform 104 to raise to provide a predetermined volume of compacted build material above the upper surface of the supply module 100.

At block 706, the controller 520 controls the layering module 512 to spread the build material provided by the supply module 100 over the build plafform 506, or over a previously formed layer of build material.

At block 708, the controller 520 controls the selective solidification module 516 to selectively solidify, for example based on a 3D object model, portions of the formed layer of build material.

Blocks 704, 706, and 708, may be repeatedly performed by the controller 520 to generate a 3D object in the build chamber 502 on a layer-by-layer basis.

A further example of a supply module is shown in FIG. 8. The supply module 800 is similar to the supply module 100 of FIG. 1, but additionally comprises a build material height sensor 802. The sensor 802 measures, or detects, the top surface of build material 110 within the build module 800. For example, the sensor 802 may be a light sensor that transmits a light beam to the top surface of build material 110 and receives a reflected light beam. In another example, the sensor 802 may be an ultrasonic height detector, or any other suitable kind of sensor. A controller 804, similar to controller 110 comprises machine readable instructions to control the supply platform 104 to compact the build material 110 until the sensor 802 indicates that the build material is compacted. Operation of the build module 800 is described below, with additional reference to the flow diagram of FIG. 9.

At block 902, the controller 804 measures, or detects, the height of the top surface of build material 110 provided in the supply module 800.

At 904, the controller 804 moves the supply platform 104 up and down, for example as described above, for example for a predetermined number of compaction cycles.

At 906, the controller 804 again measures, or detects, the height of the top surface of build material 110 in the supply module 800.

At 908, the controller 804 determines, based on the measure height, whether the build material 110 in the supply module has been compacted sufficiently. In one example, the controller 804 may determine that the build material 110 has been sufficiently compacted when the height of the build material 110 in the supply chamber has changed by a predetermined amount, for example, when the height of the powder has changed by 5%, 10%, 15%, or any other suitable amount. In another example, the controller 804 may determine that the build material 110 has been sufficiently compacted when the height of the build material 110 remains constant between compaction cycles. changed. If the controller 804 determines that the build material 110 has not compacted sufficient it performs another set of compaction cycles. If the controller 804 determines that the build material has sufficiently compacted this indicates that the build material 110 has compacted.

It should be noted, however, that a sufficient level of compaction may not be a maximum amount of compression attainable by the build material 110, but rather may be an acceptable amount of compression achievable through the performance of one or multiple compaction cycles.

The controller 804 may then supply a volume of compacted build material for spreading over a build platform.

The supply module 800 may be incorporated into a 3D printing system, such as the 3D printing system shown in FIG. 5.

It will be appreciated that example described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine-readable storage storing such a program.

All the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A build material supply module comprising:
a build material supply chamber to receive a build material;
a moveable build material supply platform; and
a controller to:
move the build material supply platform with the supply chamber in a predetermined manner to compact the build material therein.

2. The supply module of claim 1, wherein the controller is to repeatedly raise and lower the build material supply platform by a predetermined amplitude and a predetermined speed.

3. The supply module of claim 2, wherein the controller is to control the build material supply platform such that build material thereon is not moved above the upper surface of the build material supply chamber.

4. The supply module of claim 2, wherein the controller is to repeatedly raise and lower the build material supply module for a predetermined number of cycles.

5. The supply module of claim 2, further comprising a height sensor positioned above the build material supply module to sense a height of build material therewithin.

6. The supply module of claim 5, wherein the controller is to repeatedly raise and lower the build material supply platform until the sensed height of build material therewithin indicates that the build material has been compacted. to a satisfactory amount.

7. The supply module of claim 1, wherein the controller is to provide an amount of compacted build material for spreading over a build platform by raising an amount of compacted build material above the upper level of the supply module.

8. A method of preparing build material in a build material supply module, comprising:
moving a supply platform within a build material supply module in a predetermined manner to compact build material within the supply module.

9. The method of claim 8, wherein moving the supply platform comprises repeatedly raising and lowering the supply platform by a predetermined amount and at a predetermined speed.

10. The method of claim 8, wherein moving the supply platform comprises raising the supply platform such that the upper surface of build material in the supply module remains below the upper level of the supply module.

11. The method of claim 9, further comprising providing an amount of compacted build material for spreading over a build platform by raising an amount of compacted build material above the upper level of the supply module.

12. A three-dimensional printing system for use with a build material supply module as claimed in claim 1.

13. The three-dimensional printing system of claim 12, further comprising a build chamber and a build platform, or an interface for receiving a build chamber having a build platform.

14. The three-dimensional printing system of claim 12, further comprising a controller to:
move the supply platform to compact build material;
move the supply platform to supply compacted build material for layering on a build platform;
control a layering module to form a layer of compacted build material on the build platform; and
control a selective solidification module to selectively solidify portions of a formed layer of build material.

15. The three-dimensional printing system of claim 14, wherein the selective solidification module is one of: a selective laser sintering system; a binder jet system; a fusing agent and fusing energy system.
